(19) United States
(12) Patent Application Publication
(10) Pub. No.: US 2007/0061200 A1
(43) Pub. Date: Mar. 15, 2007

(54) Method for assigning transportation route naming rights

(76) Inventors: Stuart MacGregor Clyde, (US); Andre Sidler, (US)

Correspondence Address: BERESKIN AND PARR, 40 KING STREET WEST, BOX 401, TORONTO, ON, M5H 3Y2, CA

(21) Appl. No.: 11/500,371

(22) Filed: Aug. 8, 2006

Related U.S. Application Data
(63) Continuation-in-part of application No. 10/787,203, filed on Feb. 27, 2004.

(51) Int. Cl. G06Q 30/00; G06Q 99/00

(52) U.S. Cl. 705/14; 705/1

(57) ABSTRACT

A method for managing the display rights for transportation means by acquiring the display rights for such transportation means from an operating company that owns or control such transportation means and then assigning them to clients who make use of them for the purposes of a display or title in exchange for a fee. The fees that are collected from a client are distributed among the various parties involved in the process of acquiring and assigning the display rights to transportation means.

### FIELD OF THE INVENTION

The present invention relates to a method and system for acquiring and then assigning the display and naming rights for transportation means and transportation routes.

### BACKGROUND OF THE INVENTION

In an age where information is available many different forms, it is important that effective means to disseminate information are utilized. Those who wish to capture the public's attention are constantly in search of new opportunities and methods by which the public's attention can be captured. Therefore, the medium by which information is communicated to the public is extremely important better able to capture the public's attention than others.

Large scale transportation means, and in particular, large aircraft and marine craft have a captivating effect on many. Large scale transportation means, and in particular, air and marine craft are therefore well suited to serve as mediums through which information is communicated to the public. Employing the outside of these craft for purposes of displaying information will serve as a means by which to garner public attention.

As an increased amount of time is spent traveling, transportation routes also provide an effective mechanism by which information may be conveyed. Advertisements are one medium by which transportation routes are being used to convey information to travelers. However, in some jurisdictions, the respective authorities have assigned alternative descriptions/titles to certain transportation routes. For example, for streets that may be found within the entertainment district of a city, signage is prepared and displayed with regards to the alternative description/title.

### SUMMARY OF THE INVENTION

In accordance with a first aspect of the invention, there is provided a method for managing display rights for transportation means. The method comprises acquiring display rights for transportation means from an operating company and assigning the display rights to a client; and distributing any compensation from the client for said display rights.

In accordance with a first aspect of the invention, there is provided a method for assigning one or more transportation route naming rights associated with a transportation route. The method comprises making the transportation route naming rights available; providing information with respect to the transportation route naming rights; receiving offers for one or more of the transportation route naming rights associated with the transportation route; and selecting an offer and assigning one or more of the transportation route naming rights associated with the transportation route.

### BRIEF DESCRIPTION OF THE DRAWINGS

For a better understanding of embodiments of the systems and methods described herein, and to show more clearly how they may be carried into effect, reference will be made by way of example, to the accompanying drawings in which:

FIG. 1 is a block diagram of the components of a display rights management system;

FIG. 2 is a flowchart of a method in the display rights management system;

FIG. 3 is a flowchart illustrating the steps of a fee distribution method;

FIG. 4 is a block diagram illustrating interaction between the various entities and a centralized computing system;

FIG. 5 is a sample illustration of a transportation route;

FIG. 6 is a block diagram of a computer system used to implement the transportation route naming rights methods;

FIG. 7 is block diagram illustrating fields of the transportation routes database;

FIG. 8 is a flowchart illustrating the steps of a transportation route naming right assignment method; and

FIG. 9 is a flowchart illustrating the steps of a transportation route naming right approval method.

### DETAILED DESCRIPTION OF THE INVENTION

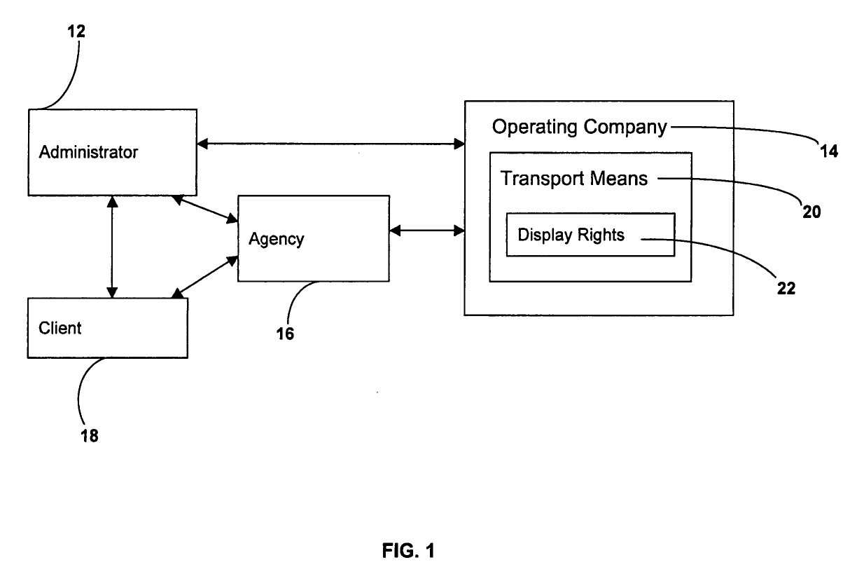

Reference is now made to FIG. 1, where a block diagram illustrating the parties involved in a display rights management system 10 is shown. An exemplary embodiment of the display rights management system 10 comprises an administrator 12, one or more of operating companies 14, one or more agencies 16 and one or more clients 18. Other parties, or entities may also be involved in the display rights management system 10 as required. The operating company 14 owns or controls one or more transportation means 20. The display rights management system 10 involves the assignment of a display right 22 for the transportation means 20 from the operating company 14 to the administrator 12 or client 18. The display rights 22 provide the right to adorn transportation means 20 with a display or title, as described in further detail below.

The display rights management system 10 may be used to secure and assign display rights 22 that are associated with airports, seaports, train stations, space ports or for any other area that may be associated with transportation means 20. The display rights management system 10 may also be used for the purposes of securing and assigning the display rights 22 for any buildings or structures.

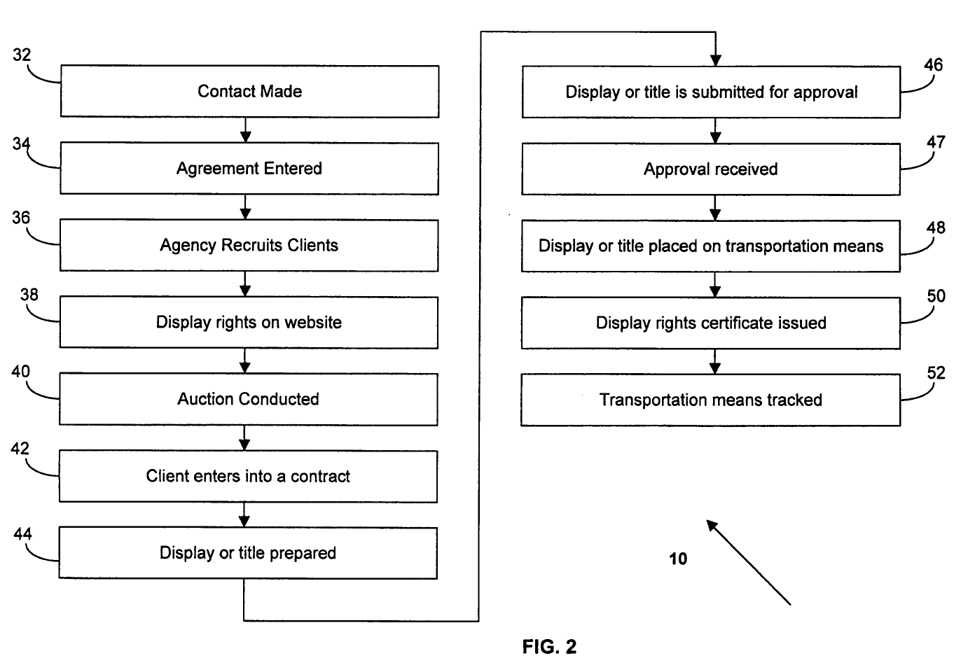

Reference is now made to FIG. 2, where a flowchart of an exemplary embodiment illustrating the steps of a method implemented in the display rights management system 10 are shown. Beginning at step 32, the administrator 12 of the display rights management system 10 contacts, or is contacted by the operating company 14 so that the administrator 12 may secure certain rights that are associated with their transportation means 20. The operating company 14 may be of varying types, including, but not limited to airlines, cruise ships, cargo companies or railways. In an exemplary embodiment, the administrator 12 works with the operating companies 14 to acquire the display rights 22 that are associated with their transportation means 20. The display rights management system 10 may include any type of transportation means 20, including, but not limited to transportation means for air, land, sea or rail. In the display rights management system 10, the operating company 14 may assign the display rights 22 to an administrator 12, or to a client 18. When the display rights are assigned to an administrator 12, the administrator 12 may subsequently reassign the display rights 22 to a client 18. The display rights 22, in one embodiment, provide the right to place a display or title on the outside of the transportation means 20. The right to place a display on the transportation means 20 allows for the use of logos, trademarks, insignias, art work, URL's (uniform resource locators) or any other combination of text or art such that they are visible on the outside of the transportation means 20.

Titles that are assigned to the transportation means 20 allow for a name to be assigned to the transportation means 20. As an example, a city that wishes to receive increased exposure, may acquire display rights 22 and have the transportation means 20 adorned with the title of their choosing, which in this example may be a reference to a name of a city.

Referring back to FIG. 2, at step 32, in order to facilitate the assignment of display rights 22, the administrator 12 or client 18 may contact the operating company 14 to attempt to negotiate and secure the display rights 22 for one or more of their transportation means 20. An operating company 14 who is interested in assigning the display rights 22 may also contact the administrator 12 or the client 18 themselves in order to facilitate the process.

At step 34, the administrator 12 and the operating company 14, enter into an agreement with respect to the assignment of the display rights 22 from the operating company 14, to the administrator 12. The display rights 22 that are secured at this step may vary. For example, the operating company 14 may provide to the administrator 12 full and exclusive display rights to all the transportation means 20 that are under their control. Alternatively, the operating company may provide temporary rights that expire after a set period of time, or with any other conditions or terms. In an exemplary embodiment, the display rights 22 may be for a limited duration expiring after a set number of years. The display rights 22 that are received by a client 18 may be for any period of time, depending on what has been agreed upon. Upon the assignment of the display rights 22 being made to the administrator 12, consideration may not be exchanged in the exemplary embodiment of the display rights management system 10. The consideration that is provided to the operating company 14 may be provided at a later stage. For example, the consideration may be provided when the client 18 has had their proposed display or title approved by the operating company 14, as described in further detail below. At step 34, an agreement is entered into, which sets out the terms and conditions that are involved in the assignment of the display rights 22. The agreement is a binding contract between the administrator 12 and the operating company 14 setting out their respective rights and obligations.

An agency 16 may be used in order to attract clients to acquire the display rights 22 that have been secured from the operating company 14. Examples of the types of agencies that may be used include, but are not limited to, a Marketing Agency, a Public Relations Agency Company, a Promotions Agency Company, and an Advertising Agency Company. The term “agency” should not be limited to the above list as it includes any entity which may facilitate interaction between any one of the administrator 12, the operating company 14 and clients 18. It is not necessary that step 36 be carried out after the display rights 22 have been secured from the operating company 14, as the agency 16 may already have recruited potential clients prior to the administrator 12 and the operating company 14 making contact. The display rights management system 10 can employ any number of agencies. Having multiple agencies employed allows for prospective clients from different parts of the world to be able to interact with an agency 16 that is most convenient. The agency 16 recruits clients 18 by various methods, include placing advertisements that inform a targeted audience that display rights 22 for a specific transportation means 20 are available for acquisition.

A client 18 that is interested in securing the display rights 22 may contact the agency 16 in order to determine the display rights 22 that are available. The agency 16 has available to it, information with respect to all the display rights 22 that have been secured by the administrator 12. The client 18 may also contact the agency 16 after having first been exposed to the display rights 22 that are available through advertisements placed by the agency 16. The prospective clients 18 are not required to first interact with the agency 16 to determine what display rights 22 are available for acquisition. Prospective clients 18 may determine which display rights 22 are available, by accessing a dedicated website at step 38.

The website has a dedicated address and contains information relating to the display rights 22 that are available for acquisition. Specifically, the website provides details of the specific transportation means 20, the potential cost, the date upon which the display rights 22 are available, the term for which they are available, and any other terms and conditions that may be applicable. With respect to the costs associated with acquiring the display rights 22 for a transportation means 20, in one embodiment, the cost is calculated on a yearly basis. The costs for the display rights 22 may vary, according to the operating company 14 from which they were secured. Some operating companies 14 may command more compensation than others, as their transportation means 20 may have greater exposure than others. The website also allows for viewing of the displays or titles that are currently in use. The website will have a picture of the transportation means 20 after it has been adorned with the display or title. The agency 16, or the operating company 14, may supply graphics, artwork and/or photographs of the transportation means 20, either before or after the application of a display or title to the transportation means 20 for use on the website. The website may also provide other information regarding the transportation means 20 that have been adorned with a display or title, including the date upon which the current agreement for the display rights 22 for the transportation means 20 expires. This allows potential clients 18 to be made aware of display rights 22 that are currently assigned that may become available in the future. The website is maintained to always accurately reflect the various display rights 22 that are available. The website is updated regularly and reflects any changes, associated with display rights 22 available for acquisition or that have been assigned. Other information that may aid the client 18 when determining whether or not to acquire display rights 22 such as the particulars of the transportation means 20 will also be available on the website. The website will list the agencies 16 that can be contacted for further information. The agencies 16 may be listed by locality, to make it easier for the prospective clients 18 to contact an agency 16 that is closest to them. A sample agreement the client 18 would enter into, if they were to acquire the display rights 22 may also be found on the website.

The display rights management system 10 allows for different mechanisms to be used for the client 18 to acquire the display rights 22 of the transportation means 20. The client 18 may enter into a contract with the agency 16 or the administrator 12 with respect to the display rights 22 by first participating in an auction at step 40. Auctions may be used for all the display rights 22, whether or not the associated transportation means 20 has been commissioned into service. If an auction is conducted, it can either be a live auction or an Internet based auction. The prospective clients 18 who participate in the auction are able to obtain information about the display rights 22 from the website or the agency 16. The client that acquires the display rights 22 for non commissioned transportation means 20 will have the particular display or title that has been approved by the operating company 14 applied to the transportation means 20 prior to the transportation means 20 being commissioned. In an exemplary embodiment as per the terms of the agreement associated with assigning of the display rights 22, the displays or titles that will adorn the craft may be included in any promotional materials used by the operating company 14 that relate to the new transportation means 20.

If the client 18 acquires the display rights 22 from the administrator 12, the client 18 may not receive the full display rights 22 that were secured by the administrator 12. The contract that is entered into at step 42 with respect to the acquisition of the display rights 22 by the client 18, outlines the respective rights and obligations, and terms and conditions between the parties involved. The same terms and conditions apply when the client 18 acquires the display rights 22 through an auction or through an agreement that they reached with the agency 16 or the administrator 12. The consideration that is to be given, if any, when it is to be given, and the rights the operating company 14 has with respect to the display or title are included in the terms and conditions.

If the client 18 has display rights 22 associated with a commercial transportation means 20 that is used for public transport, such as for example an airline or cruise ship, the title that has been placed on the outside of the transportation means 20 may be publicized and used in reference to the transportation means 20 wherever possible. The operating company 14 will have agreed as per the terms of the agreement they entered into, that for any transportation means 20 that have a title assigned to them, the operating company 14 will make use of the title when welcoming passengers on board. For example, an announcement can be made to the effect “Welcome aboard the spirit of Paris”, if “The Spirit of Paris”, was the title that was given to the transportation means 20 (i.e. a plane or train or ship carrying passengers).

Information in the form of photographs, pamphlets, brochures or any other informational material regarding the display or title, and its significance will be made available for passengers of any commercial transportation means 20. As per the terms of the agreement between the administrator 12 and the operating company 14, or the client 18 and the commercial transportation means 20 will carry information when appropriate with respect to the display or title.

At step 44, once the client 18 has acquired the display rights 22, the client 18 may work in conjunction with the administrator 12 and/or the agency 16 to prepare the display or title. Once the display or title has been prepared, the proposed display or title is submitted to the operating company 14 at step 46. The operating company 14 retains final say on the display or title, as they may need to respect political religious or other sensitivities and legal requirements. If the proposed display or title does not receive approval from the operating company 14 at step 47, the agency 16 and the client 18 will revise the proposed display or title in order that it conforms to what the operating company 14 requires.

Once a client 18 has successfully acquired the display rights 22, an announcement or advertisement will be used to congratulate the client 18 on their successful acquisition of the display rights 22. The text of the advertisement includes details regarding the transportation means 20 and where it is likely to be seen on its various travels, and any information relating to the client 18. This advertisement or announcement will be placed in print media, and preferably in localities that have a proximate relationship to the transportation means 20 and its travels. The advertisement or announcement may be placed however in different mediums, and is not limited to print.

Once approval for the display or title has been received from the operating company 14 at step 47, the display or title may be placed on the transportation means 20 at step 48. Also, once approval has been received from the operating company 14 at step 47, any consideration may be provided. The consideration, if any, will be collected by the agency 16 or operating company 14 from the client 18 and will be distributed among the various parties. For displays or titles that have been placed on transportation means 20 prior to their commissioning, the clients 18 will have the added benefit of having their display or title receive increased exposure, due to any publicity the transportation means 20 may receive when it is first brought into service.

After the transportation means 20 has been adorned with an acceptable display or title, a display rights certificate may be issued to the client at step 50. A display rights certificate may be created by the agency 16 or the administrator 12, and specifies the details of the transportation means 20. The details may include but are not limited to, the serial number, year of manufacture, the model, place and country of manufacture, expected hours of operation per year, and the route it may take on its travels, and any technical specifications. The display rights certificate may include a picture of the transportation means 20 after having been adorned with the display or title. Along with the display rights certificate, the client 18 may also receive a scale model of the transportation means 20 that has their respective display or title. Along with potentially receiving the display rights certificate, and a scale model, the client may also receive a photograph where the client 18 is shown with the transportation means 20 associated with their display or title. The display rights certificate, the scale model, and the photograph of the transportation means 20 and the client 1 8 may be received by the client 18 as part of a package or separately depending on the arrangement between themselves and the administrator 12 or agency 16.

The display rights management system 10 provides functionality on the website by which the client 18 is able to track where the transportation means 20 that have their displays or titles are located at any point in time. The website also provides a means by which the clients 18 who have acquired the display rights 22 are able to track the location of their particular transportation means 20 at any point in time. The operating company 14 provides to the administrator 12 or to the website administrator, the arrival and departure times of the transportation means 20 on their respective journeys. The travel itinerary of the transportation means 20 for future travels will also be provided by the operating company 14, if available. If the operating company 14 makes use of internal travel tracking, as is done by commercial airlines, by way of the agreement that was entered into by the administrator 12 and the operating company 14 the internal flight tracking information may be made available to the client 18 who acquires the display rights 22. This provides the client 18 with the ability to track where the respective transportation means 20 that has their display or title is located. If the operating company 14 does not employ an internal flight tracking mechanism, then the operating company 14 may be required by way of the agreement to supply more generic travel information, such as the departure time, the arrival time, departure city or port and arrival city or port of the transportation means 20 on its travels. Also, for the clients 18 that have assigned titles to the transportation means 20, the client 18 will be able to search for the location of transportation means 20 by inputting the title into a field that allows them to browse the relevant travel records respectively. Regardless of the information the client 18 is accessing, and regardless of whether it is being accessed by reference to titles, a password may be provided to the client 18 to ensure only that appropriate parties are accessing the information that would allow for tracking of the transportation means 20. The website may also operate so as to not require a password to view information about a transportation means associated with a display or title.

The administrator 12, by way of agreement, may relieve other parties of their responsibilities. As an example, with respect to the operating company 14 or agency 16 who may be responsible for providing any graphics, art work or photographs of the transportation means 20 for use on the website, the administrator 12 at their discretion may relieve the operating company 14 and the agency 16 of these obligations.

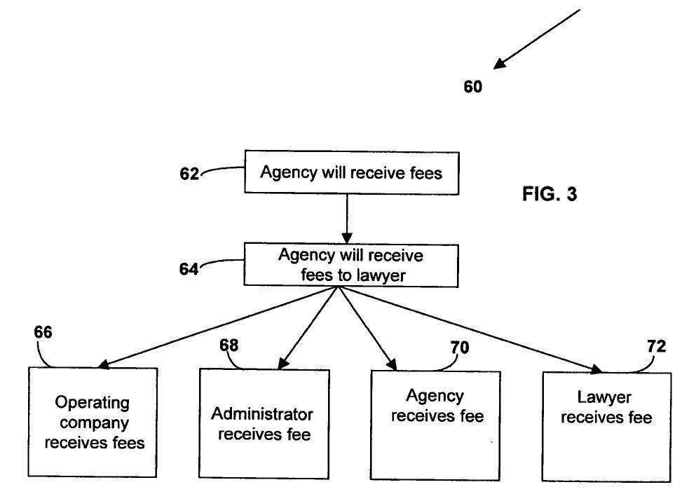

Referring now to FIG. 3, a flowchart detailing the steps of an exemplary embodiment of a consideration distribution method 60 is shown. Method 60 begins at step 62, where if a fee is paid for the acquisition of the display rights, it will be transferred from the client 18 to the agency 16. The client 18 is not required to submit the fees, directly to the agency 16, as the fees may be submitted directly to a second or third party who may then be responsible for distributing the fees. With respect to the second or third party to whom the fees that may have been received are transferred to, it is envisioned that lawyers or accountants or any other suitable individual or organization be employed in order to carry out this role. In method 60, the various parties have agreed to share the proceeds from the assignment of the display rights 22. The respected parties may have either agreed to receive a flat fee or a percentage of the fees. The fees may be shared based on a variable percentage fee basis where the percentage fee is not fixed and will be determined based on an incentive based system at the discretion of the administrator 12. The fees are received by the agency 16 and transferred in their entirety to the second or third party at step 64. In one embodiment of the consideration distribution method 60, with respect to any fees that may have been received, certain parties will receive compensation based on a flat fee and certain parties will receive compensation based on a percentage fee basis. The second or third party will receive a flat fee for any work they are to perform. The second or third party will be in the employ of the administrator 12 and will be responsible for distributing the fees in their appropriate shares or amounts to the respective parties involved. In an exemplary embodiment the payment that is made by the second or third party to the operating company 14 at step 66 is a percentage fee. Payments that are made by the second or third party to the administrator 12 at step 68 will be made on a percentage fee basis. The payments that are made by the second or third party to the agency 16 at step 70 are made on a percentage fee basis. The payment that is made to the administrator 12, operating company 14 or agency 16 may become a combination of a flat fee and a percentage fee with the potential for an additional payment based on a variable incentive scheme through a variable percentage fee. One example of a proposed share to be received by parties in an example embodiment is as following; the administrator 12 may receive 35% of the fees received from the client 18, the operating company 14 may receive 20%, the agency 16 may receive 15% and the remaining 30% that has not been distributed may be used in order to cover any administrative costs that may be involved, as well as paying the flat fee that is to be paid to the second or third party at step 72. These percentages mentioned for purposes of example, and other percentages may be used.

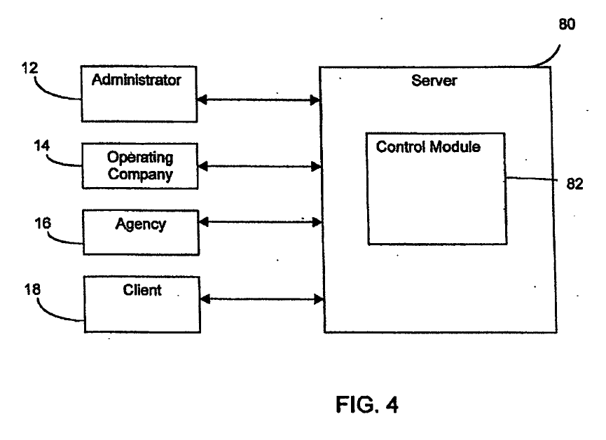

Reference is now made to FIG. 4, where an exemplary embodiment illustrating the interaction between various entities and a server 80 and a control module 82 are shown. The server 80 associated with the display rights management system 10 comprises the control module 82 which may be used to operate the website. The administrator 12 may interact with the server 80 in order to maintain and access information relating to the display rights 22 of the transportation means 20. The operating company 14 may interact with the server 80 with respect to accessing information regarding the transportation means 20 that are part of the display rights management system 10. The operating company 14 may also interact with the server when providing information relating to the itinerary of the transportation means 20. The agency 16 may interact with the server 80 with respect to maintaining and accessing information relating to transportation means 20 and the display rights 22 associated with those transportation means 20. The client 18 may interact with the server 80 in order to access information with respect to the transportation means 20 that are part of the display rights management system 10 which may have their display rights 22 available for acquisition, as well as for potentially engaging in an auction that may be used in order to attempt to assign display rights 22 to clients 18. Clients 18 may also interact with the server 80 when tracking the location of transportation means 20.

As the display rights management system may be used to acquire the right to name a transportation means, a system and method is now described that allows for naming rights for transportation routes to be acquired.

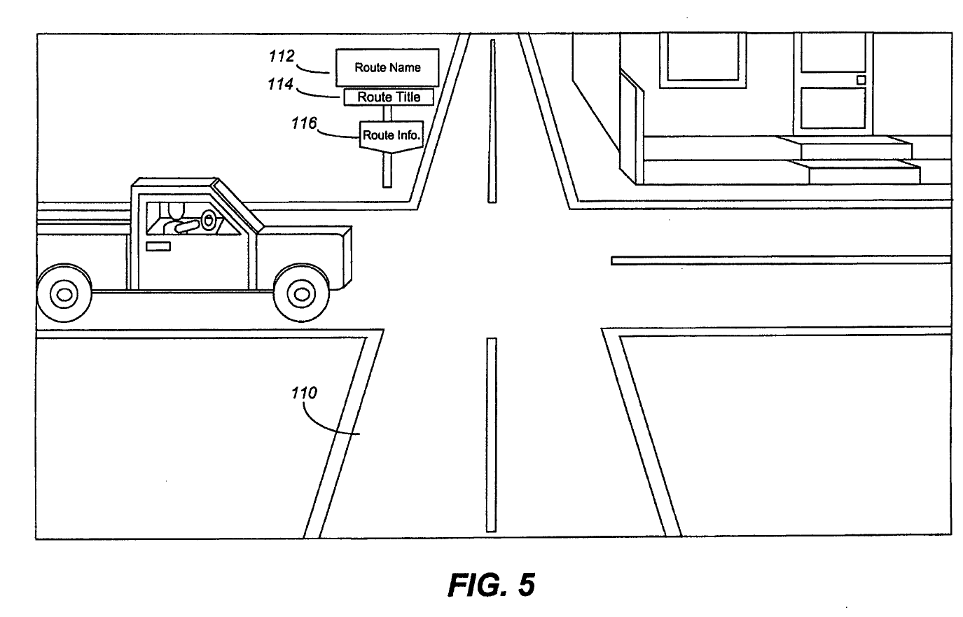

Reference is now made to FIG. 5, where a figure illustrating a sample transportation route and the one or more transportation route naming rights associated with the transportation route are shown. In FIG. 5, a transportation route 110 is shown. The transportation route 110 as shown in FIG.5 is a roadway. However, the transportation route 110 need not be limited to a roadway and may be any route that is used for transportation of transport vehicles or people. Transportation routes may include, but are not limited to, streets, roads, avenues, crescents, highways, water routes, walkways, walking trails, hiking trails, bridges, subway routes and tunnels. Transportation vehicles may include, but are not limited to cars, planes, trains, ships, motorcycles and any other such method of transportation. The transportation route 110 has associated with it, one or more transportation route naming rights. In this exemplary embodiment, the transportation route naming rights are comprised of a transportation route name 112 and a transportation route title 114. The transportation route name 112 is similar to a street or road name associated with transportation routes. Examples of such transportation route names 112 provided for purposes of illustration, include XYZ Avenue, or XYZ Street. The transportation route title 114 is a title associated with the transportation route 110 that serves as an additional means by which the transportation route may be identified. The transportation route title 114 is separate from the route name that is given to the transportation route 110. The transportation route title 114 may be used as a descriptor of the areas through which the transportation route 110 travels. For example, for a transportation route 110 that passes through a city or town's entertainment area, the route title 114 may be “The Entertainment District”. The route titles 114 may also refer to advertising campaigns and/or slogans that are used by companies, and may be used to provide a means by which companies may market themselves or to impart other information. Also, as shown in FIG. 5, a display 116 may be placed upon the transportation route 110 detailing the history or other promotional material related to the entity that has acquired one or more of the naming rights for the transportation route 110.

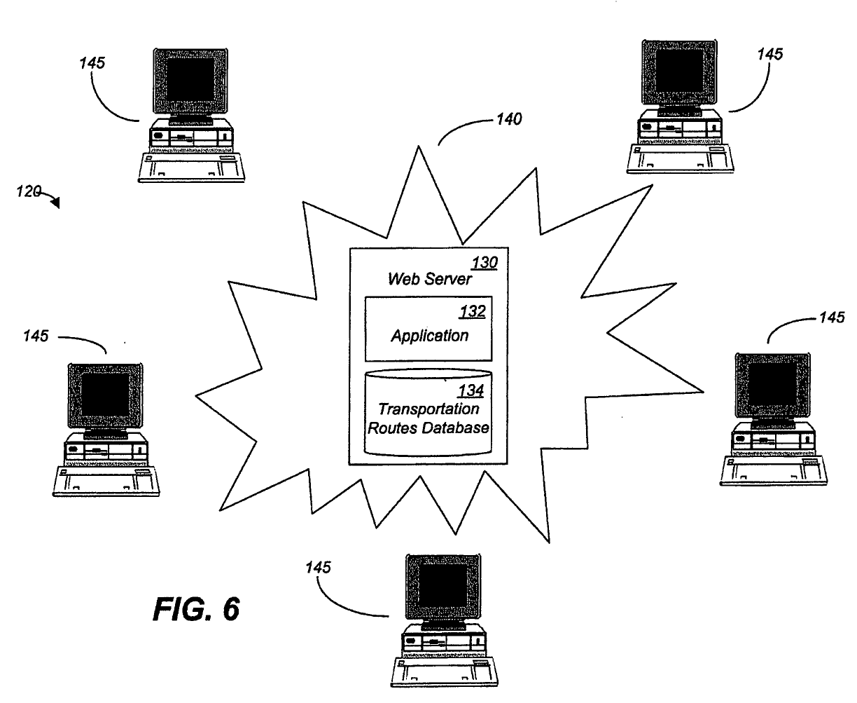

The transportation route naming rights will generally be controlled by different entities depending on laws in the local jurisdictions. The entities that determine the names given to the transportation routes 110 vary depending on the route and the jurisdiction in which the route is located. For purposes of example, the entities may include, but are not limited to, the local municipality, the state/province/county, the country, a property developer, the local borough, the planning department and any other individual or institution that has been given the legal right to specify names associated with transportation routes. In many situations, the right to name a transportation route vests with the planning department of the local town council. For purposes of this application, the party or parties that have the right to decide on the transportation route naming rights associated with a transportation route 110, will be referred to as an authorized party or authority. The party that acquires one or more of the naming rights associated with the transportation route will be referred to as the naming party. The party that is interested in acquiring one or more of the transportation route naming rights is referred to as an interested party.

Where transportation route naming rights are available for acquisition, the authorized party or authority may use various methods to facilitate the acquisition of the naming rights. One such method involves the authorized party or authority dealing directly with the naming party or an agency that helps find interested parties. Another method, as is described with regards to FIG. 6, involves the use of a computer system.

Reference is now made to FIG. 6, where one embodiment of a transportation route naming rights system 120 that may be used to facilitate the acquisition and assignment of transportation route naming rights is shown. The naming rights system 120 in this embodiment allows users of the system to list electronically transportation routes that have one or more of their naming rights available for acquisition. The system 120 in one exemplary embodiment is comprised of a server 130, an application 132, a transportation routes database 134, a communication network 140, and one or more communication devices 145.

The server 130 is a computing device that comprises a processor, memory means, input devices, and functionality that allows for a network connection. The server has associated with it, an application 132 and a transportation routes database 134. The application 132 and the transportation routes database 134 are either resident upon or accessible to the server 130. The application 132 is a software application that allows for the exchange of information between users of the system 120, creates web pages upon request, and manages the transportation routes database 134. The transportation routes database 134 is used to store listings of all the transportation routes 110 that have transportation route naming rights associated with them that have been assigned, or are still available for assignment.

The communication network 140 is any network capable of allowing data transfer between devices that connect to a network. The communication network 140 for purposes of this embodiment, is the Internet.

The communication device 145 is any device that has means for a network connection, and that allows for input mechanisms to be associated with the device 145. Examples of such devices may include, but are not limited to personal computers, slim line computer, laptops, or handheld computing devices. The device 145 has a processor (a central processing unit), peripheral devices, input means, and a display terminal. The system 20 allows user to connect with a server 130 for purposes of acquiring transportation naming rights or inquiring as to the status and or particulars of transportation naming rights that may be available for acquisition.

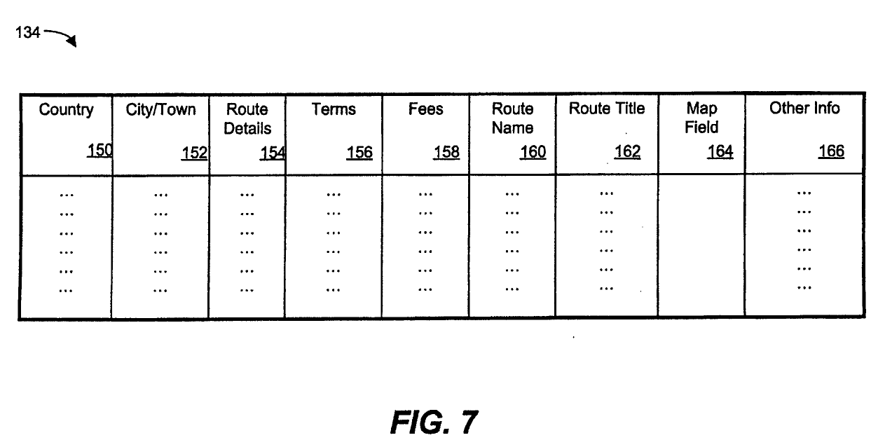

Reference is now made to FIG. 7, where one embodiment of the fields of the transportation routes database 134 is shown. The fields of the transportation routes database in one embodiment include a country field 150, a city/town field 152, a route details field 154, a term field156, a fees field 158, a route name field 160, a route title field 162, a map field 164, and an other information field 66. The country field 150 lists the country of the city/town. The city/town field 152 provides geographic information as to the city/town in which the transportation route is located. The route details field 154 lists the information relating to the transportation route 110, and may include particulars relating to the area through which the transportation route travels, and may include particulars relating to the history of the area, demographics, or any other such information. The term field 56 will specify the term for which the naming rights are available if the rights have not been assigned, or if they have been assigned, the term for which they have been acquired. The fees field 158 specifies the fee structure associated with the acquisition of the naming rights. The fees structure may be based on a one time flat fee, annual fees, a listed reserve price (where an auction is used), or fees that are based on any other associated structure. The route name field 160 stores the route name 112 once it has been assigned. The route title field162 is used to store the route title 114 that may be associated with any transportation route 110. The map field 164 stores either a map that highlights the transportation route 110, or grid coordinates that may be used to generate a map, such as those beginning and ending coordinates used by map creation services such as mapquest™. The other information field 66 is used to store any additional information that may be related to the transportation route, and may include, but is not limited to, the expected completion date (if the route is under construction), and the date on which the naming rights have been assigned, if applicable.

Reference is now made to FIG. 7 where the steps of a transportation route assignment method 200 are shown. Method 200 facilitates the assignment of transportation routes naming rights.

Method 200 begins at step 205, where an authorized party makes one or more transportation naming rights associated with a transportation route 110 available for acquisition. Authorized parties may make the one or more transportation route naming rights available at any time. However, it is envisioned, that the transportation route name 112 will be made available when a transportation route 110 is to be named for the first time, as changing the name of a transportation route once it is known to the public may result in confusion. The transportation route title 114 will also be made available when the transportation route name 112 is made available for the first time, however, it may also be made available at any time subsequent to that. In one embodiment, step 205 may be implemented through the authorized party or authority making use of a website (not shown) that has been established and that is maintained by the server 130. In an alternative embodiment, the authorized party or authority may make the naming rights available by contacting an agency to help facilitate their acquisition or by directly engaging with interested parties. The agent who may be any authorized individual/entity that has been granted the right to administer or assist in the administering of the system 120, may then proceed to make the naming rights available for acquisition upon the website. At step 205, the authorized party may be required to submit some form of proof that they are the entity that has been entrusted with the responsibility/legal obligation to choose a name for the transportation route 110. The authorized party, or agent, acting on their behalf, will provide all the information as is required for the transportation routes database 134.

Method 200 then proceeds to step 210 where the particulars of the transportation route 110 for which one or more naming rights are available may be viewed upon the website or through other suitable mediums (for example television, print media, calling the agency or authorized party). When a website is used to assign the naming rights, the fields of the transportation route database 134 are populated such that the web server application 132 is able to extract the information from the database 34 and to generate a web page when required. The website will display information for transportation routes 110 that have had their naming rights assigned and ones for which the naming rights may be acquired.

Method 200 then proceeds to step 215, where interested parties view the information related to transportation route naming rights that are available on the website. The website incorporates search functionality that allows the user to search for transportation routes 110 that have naming rights associated with them.

Parties may attempt to acquire the naming rights associated with a transportation route through various means. Parties may attempt to acquire the rights by submitting an offer with the required fees. Alternatively, the interested party may also be required to engage in an Internet based auction, where the rights will be assigned to the highest bidder. Another alternative involves the interested parties submitting offers (similar to a tendering process) and then having the authorized party or approved agent decide upon the various offers that have been received. As part of step 220, the authorized party or approved agent has the right to accept or decline any bid/offer, and put in place any terms that the naming party must abide by. The authorized party or approved agent will be vested with the authority to make the determination as to whether any offer/bid from an interested party is acceptable, and may reject the bid/offer if they wish to do so.

Method 200 then proceeds to step 225 where the information in the transportation routes database 134 is updated with the name and/or title that has been specified by the purchasing party and agreed to by the authorized party.

Method 200 then proceeds to step 230 where the transportation route name 112, and transportation route title 114 are displayed upon the respective transportation route 110. The route name 112 and route title 114 may be displayed such that they are visible in more than one area upon the transportation route 110.

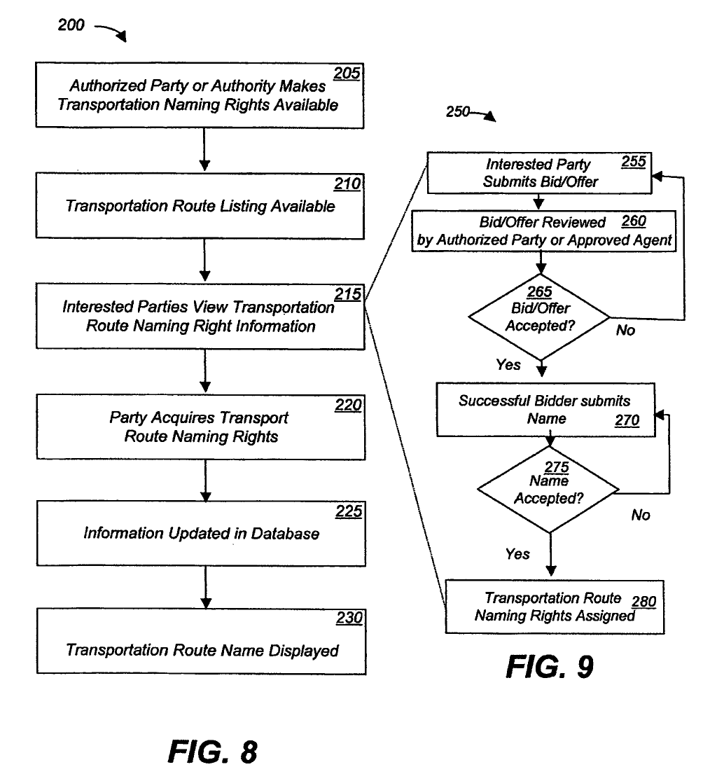

Reference is now made to FIG. 8, where the steps of a transportation route approval method 250 are shown. The approval method 250 is undertaken when the authorized party, or approved agent, is required to approve the name or title that is being proposed for the particular transportation route. The approval method is also engaged when the authorized party, or approved agent, desires to approve of the party acquiring the rights, or of any particular terms and conditions that are attached to the acquisition of the naming rights.

Method 250 requires that the authorized party has made the transportation rights available for acquisition, which is shown in method 200 at step 205. In reference to FIG. 8, method 250 will be undertaken at step 215 where the authorized party or approved agent may receive a bid/offer with respect to one or more naming rights associated with a transportation route 110. Method 250 begins at step 255, where an interested party has submitted a bid/offer. The authorized party may require the bid/offer to be accompanied by specific information (which may include particulars of the entity submitting the bid/offer, the proposed name and or title that is to be associated with the transportation route or any other such information).

Method 250 then proceeds to step 260, where the authorized party reviews the particulars of any bid/offer that is received for any naming rights associated with the particular transportation route 110. Depending on the method that is employed for assigning the transportation rights (i.e. whether an auction is employed) the authorized party or approved agent, reviews the particulars of any bid/offer that is received for the particular transportation route 110. As stated above, the bid/offer may be reviewed by the authorized party or approved agent for compliance with any of the authorized party's requirements, including fees, terms, corporate structure, history, proposed name and proposed title.

At step 265, a check is performed to determine whether the authorized party or approved agent has accepted the bid/offer that was submitted. If it is determined at step 265, that the bid/offer is accepted, then method 250 proceeds to step 270.

If at step 265, it is determined that the bid/offer has been rejected, method 250 returns to the step where the interested party may submit another bid/offer for the respective naming rights.

At step 270, the party whose bid has been accepted, then submits the name and or title that is to be associated with the transportation route naming rights. A check is performed at step 275, where the authorized party or approved agent reviews the requested names, and decides whether the requested names are allowed. If it is determined at step 275 that the requested names are allowed, method 250 proceeds to step 280. If it is determined that the requested name is not allowable, method 250 returns to step 270 where another name is submitted.

At step 280 for the transportation rights to be assigned to the respective party, the naming party and authority or authorized agent enter into a contractual agreement. The contractual agreement may specify any terms and conditions that both parties agree to.

The present invention has been described with regard to preferred embodiments. However, it will be obvious to persons skilled in the art that a number of variants and modifications can be made without departing from the scope of the invention as described herein.

We claim:

1. A method for assigning one or more transportation route naming rights associated with a transportation route, the method comprising the steps of:
making the transportation route naming rights available;
providing information with respect to the transportation route naming rights;
receiving offers for one or more of the transportation route naming rights associated with the transportation route; and
selecting an offer and assigning one or more of the transportation route naming rights associated with the transportation route.

2. The method of claim 1, wherein one or more transportation route naming rights associated with the transportation route are made available over the Internet.

3. The method of claim 1, wherein the one or more transportation route naming rights associated with the transportation route naming rights are assigned through an auction.

4. The method of claim 3, where the auction is an Internet based auction.

5. The method of claim 1, where the transportation route naming rights comprise a transportation route name and a transportation route title.

6. The method of claim 1, further comprising the steps of approving the use of the one or more transportation route naming rights.
